(19) United States
(12) Patent Application Publication
(10) Pub. No.: US 2020/0093209 A1
(43) Pub. Date: Mar. 26, 2020

(54) HEAD ITCH RELIEF TOOL

(71) Applicant: Mary Reed, Minneapolis, MN (US)

(72) Inventor: Mary Reed, Minneapolis, MN (US)

(21) Appl. No.: 16/385,812

(22) Filed: Apr. 16, 2019

Related U.S. Application Data
(60) Provisional application No. 62/735,964, filed on Sep. 25, 2018.

(51) Int. Cl. A41G 5/00; A42B 1/00

(52) U.S. Cl. CPC A41G 5/00; A61Q 5/00; A42B 1/00

(57) ABSTRACT

Itching of the scalp is alleviated by providing a tool that will not penetrate the skin and that is always handy because it can be worn on the head and is buried beneath the hair when not in use.

### CROSS-REFERENCED TO RELATED APPLICATIONS

This application claims priority to U.S. Provisional Patent Application Ser. No. 62/735,964 entitled “HAPPY SCRATCH”, filed Sep. 25, 2018.

### STATEMENT REGARDING FEDERALLY SPONSORED RESEARCH OR DEVELOPMENT

Not applicable

### BACKGROUND OF THE INVENTION

### I. Field of the Invention

As a hair stylist, the inventor has witnessed numerous clients with fresh or scabbed over head wounds on the scalp beneath the hair. This is quite common when the client wears hair extensions, hats or other head wear. This is also quite common with protective and stabilized hair styles, e.g., free flowing braids, scalp hugging corn rows, French braids, twists, knotted and similar weaves. Such head wounds are caused by the steps taken by the clients to relieve itching of the scalp. More specifically, such wounds are caused by fingernails or other devices used by the clients to alleviate the itching. Examples of devices used to alleviate the itch include such items as pencils, rulers, silverware and other elongate objects with a sharp point. Basically any device that is handy with a sharp point could be used.

Rupturing the skin in such a fashion exacerbates scalp itching as the wounds heal. More significant, such wounds provide a path of entry into the body of infectious agents including fungus and bacteria. Such infectious agents are typically present on the exterior of the scalp and in the hair. Such infectious agents are also present on the tools or under the fingernails used to try to relieve the itching.

Thus, there is a real need for a tool that may be used to relieve itching of the scalp that will not rupture, puncture, break or further irritate the skin when used, and which is always handy.

### SUMMARY OF THE INVENTION

The foregoing problems are solved by providing an itch relief tool comprising an elongate band having a first end, a second end and a transition zone. Between the first end and the transition zone, the band has a first curved portion. This first curved portion has a first radius of curvature. This radius of curvature is the radius of an imaginary circle completing the curve. Between the second end and the transition zone, the band has a second curved portion shorter than the first curved portion. This second curved portion is flattened such that it has a second radius of curvature longer than the first radius of curvature.

The tool also includes bulbous tip portions at each of the first and second ends of the elongate band. These may be a coating applied to the elongate band. Alternatively, the bulbous tip portions may be integrally formed with the rest of the band as a single piece.

The band may be made of a variety of materials including various metallic materials such as carbon steel, bronze, aluminum, or nickel titanium. Naturally occurring materials, such as ivory, wood, porcupine quills or bone may be used. A variety of plastic materials may also be used to form the band. Use of shape memory materials having a transition temperature at or below body temperature (e.g., 80° F. to 98.6° F.) offers a variety of advantages when used to form the band. Plastic materials may also be used to coat the ends of the band to form the bulbous tip portions. The materials selected should permit the band to be easily cleaned and sanitized. Likewise, the tool should not have any grooves or recesses which might make the tool difficult to clean.

The tool is adapted to glide between the hair and the scalp when in use. Further, the second curved portion is adapted to be gripped by the hand of a user allowing the tool to be manipulated by the user while either the bulbous tipped portion at the first end of the band, the first curved portion of the band, or both the bulbous tipped portion at the first end of the band and the first curved portion of the band engages the scalp to address an itch. Further, the itch relief tool is adapted to be stored on the user's head beneath the user's hair when not in use.

More specifically, the tool is curved and dimensioned to extend over the top of the head of a user above the ears of the user. To accommodate sizes of the heads of various users, various dimensions may be employed. For example, the shortest distance between the first end and the second end may be in the range of 7 to 9 inches, and the shortest distance between the first end and the transition zone may be in the range of 4.5 and 5.5 inches. Also, the greatest depth of the tool may be varied. A suitable range of depths is 2.75 inches to 3.5 inches. The greatest depth of the tool is determined by drawing an imaginary line between the first end and the second end and then measuring perpendicularly from that imaginary line to the apex or top of the band.

The thickness and width of the band may vary. Ideally, the thickness is preferably less than ⅛ inch so that, when stored on the head, it is buried in and does not protrude beyond the hair.

Various modifications may, of course, be made. For example, a decorative designed can be applied to the band and bulbous tips, or the band and bulbous tips may be colored to match the hair color of a user to camouflage the tool making the tool easier to hide beneath the user's hair. Additionally, a decorative element such as a bow, a ribbon, beads, flowers or the like may be coupled to the band and held in place by the tool on the head.

### BRIEF DESCRIPTION OF THE DRAWINGS

The foregoing features, objects and advantages of the invention will become apparent to those skilled in the art from the following detailed description of the preferred embodiment, especially when considered in conjunction with the accompanying drawings in which like numerals in the several views refer to corresponding parts:

FIG. 1 is a front view of a head scratching tool made in accordance with the present invention;

FIG. 2 is a rear view of the tool of FIG. 1;

FIG. 3 is a first end view of the tool of FIG. 1;

FIG. 5 is a second end view of the tool of FIG. 1;

FIG. 6 is a bottom view of the tool of FIG. 1;

FIG. 7 shows how the tool of FIG. 1 is gripped and used to scratch the head of a user; and

FIG. 8 shows how the tool of FIG. 1 may be stored on a user's head underneath the user's hair.

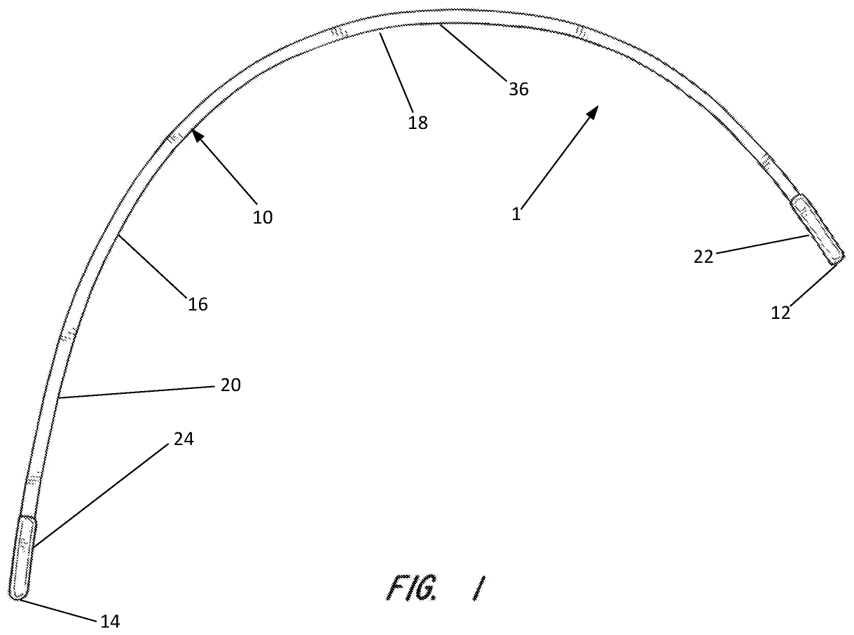

### DESCRIPTION OF THE PREFERRED EMBODIMENT

This description of the preferred embodiments is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion. These relative terms are for convenience of description and do not require that the apparatus be constructed or operated in a particular orientation. Terms such as “connected”, “connecting”, “attached”, “attaching”, “join” and “joining” are used interchangeably and refer to one structure or surface being secured to another structure or surface or integrally fabricated in one piece, unless expressively described otherwise.

The drawings show a head scratching tool 1 comprising an elongate band 10 having a first end 12 and a second end 14. The band also has a transition zone 16.

Extending between first end 12 and transition zone 16 is a first curved portion 18. Extending between the second end 14 and the transition zone 16 is a second curved portion 20. The second curved portion 20 is shorter in length than the first curved portion 18.

Curved portion 18 has a first radius of curvature, i.e., the radius of an imaginary circle including curved portion 18. Curved portion 20 has a second radius of curvature, i.e., the radius of an imaginary circle including curved portion 20. As shown, curved portion 20 is less curved than curved portion 18. As such, curved portion 20 has a longer radius of curvature than curved portion 18. The arrangement of curved portions 18 and 20 allow the tool 1 to fit snuggly around (over the top) of the head for storage on the head of a user when not in use. This makes the tool readily accessible for use to achieve the intended purpose.

Each end of the tool 1 is provided with a bulbous tip portion. A first bulbous tip portion 22 is located at the first end 12 of the elongate band 10. A second bulbous tip portion 24 is located at the second end 14 of elongate band 10. These tip portions 22 and 24 may be formed as a single piece with the rest of the band 10 or may be a separate coating (e.g., a plastic coating) applied to the first end 12 and the second end 14.

Various materials may be employed to construct the band 10. These include natural materials such as ivory, bone, wood, stone (such as soapstone) and porcupine quills. The tool 1 may be carved from such materials so that it includes both the band 10 and the bulbous tip portions 22 and 24. Likewise, the tool 1 may be molded as a single piece from a plastic material with the band 10 and first and second bulbous tip portions 22 and 24 formed integrally together in a single molding operation all at one time.

Any non-allergenic metallic material may also be used. Bronze, carbon steel and nickel titanium are suitable. Other materials such as aluminum, platinum, gold and silver may also be used without deviating from the invention. When the band 10 is formed of a metallic material such as those listed above, the bulbous tip portions may be formed of a plastic material covering or coating the ends 12 and 14. As used herein, the terms coating and covering are used interchangeably.

Nitinol (a class of shape memory alloys of nickel titanium) and other shape memory materials may be employed to form the band 10. Such shape memory materials may be temperature sensitive. Temperature sensitive shape memory materials are well known and are formulated to change from a first shape to a second shape when the material reaches its transition temperature. When a band 10 made of such a temperature sensitive shape memory material reaches its transition temperature, the band will transition from a straight shape or a tightly coiled shape to the shape shown in the drawings. The transition temperature is preferably at or just below body temperature (e.g., between 80° F. and 98.6° F.).

Whatever materials are selected, the materials should ensure that the band 10 is relatively stiff. The materials use should also allow the tool 1 to be readily and repeatedly cleaned and sanitized. The profile of the tool 1 should not include any sharp edges or points. The profile of tool 1 should also not include any recesses, gaps, grooves or other areas where oils from the hair, hair products, dirt or grime may accumulate. The materials selected and the profile of the tool 1 should also permit the tool 1 to glide between the hair and the scalp.

The dimensions of the tool 1 may vary. The dimensions discussed below are suitable for use by most adult women allowing the tool to be worn (stored) on the head of a user when not being employed to scratch an itch.

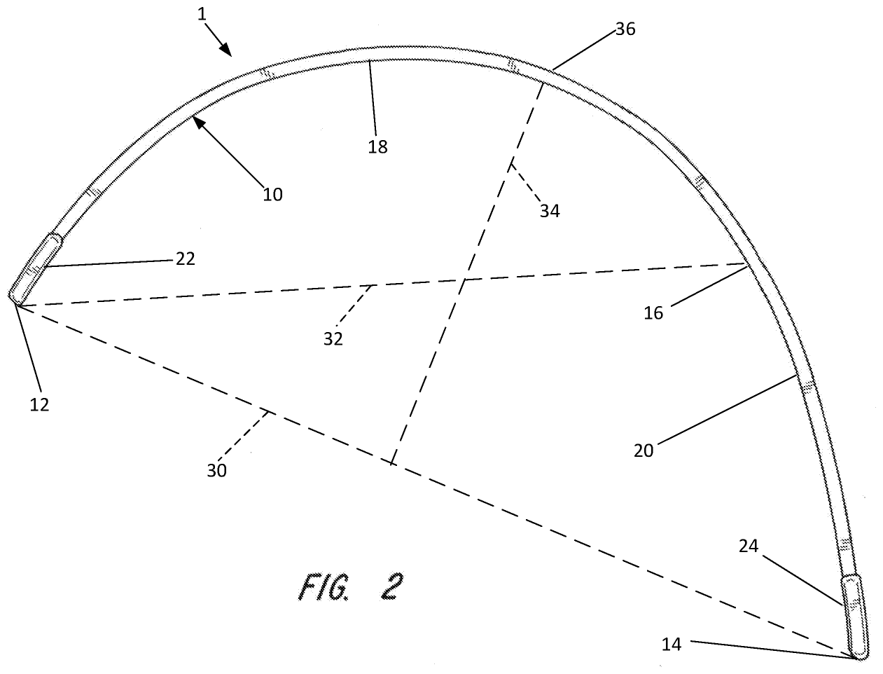

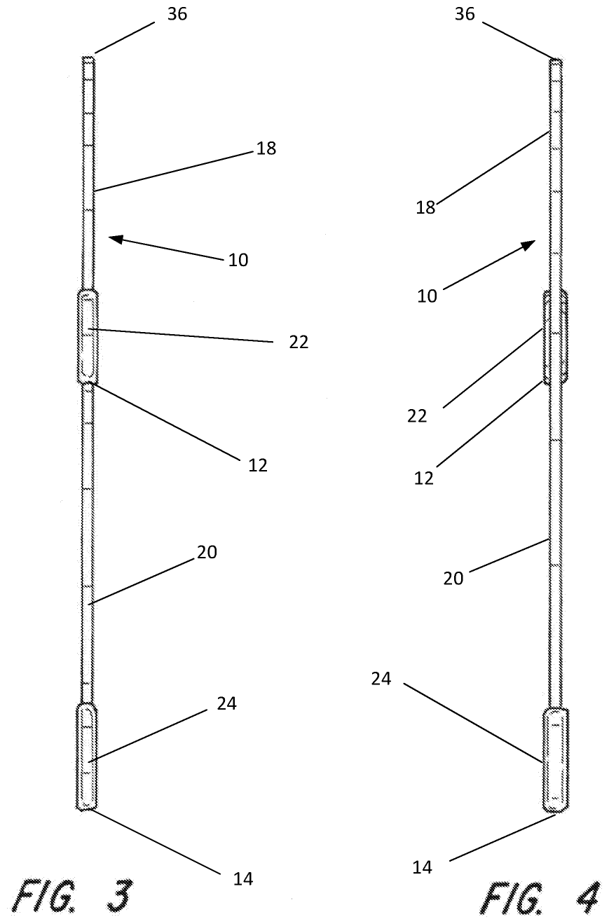

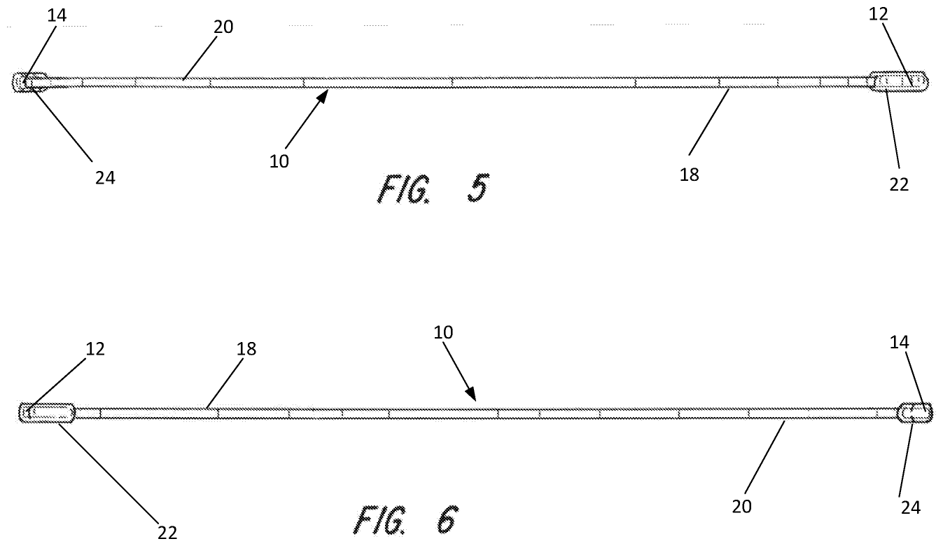

FIG. 2 shows a first imaginary line extending between first end 12 and second end 14. This line represents the shortest distance between the first end 12 and the second end 14. This distance is preferably between 7 and 9 inches.

FIG. 2 also shows a second imaginary line 32 extending between first end 12 and the transition zone 16. Line 32 represents the shortest distance between first end 12 and the transition zone 16. This distance is preferably between 4.5 and 5.5 inches.

FIG. 2 shows a third imaginary line 34. This line extends perpendicularly from line 30 to the apex (or top) 36 of the band 10. Line 34 represents the greatest depth of the tool 1. The greatest depth is preferably between 2.75 and 3.5 inches.

When the first and second bulbous tip portions 22 and 24 are in the form of a coating (e.g., covering) applied to the ends 12 and 14 of band 10, it is important that the coating is firmly secured to the ends 12 and 14 such that the coating will not come off during normal use or cleaning. To ensure the bulbous end portions 22 and 24 remain fixed to the band 10, bulbous end portion 22 preferably extends more than one-half inch from first end 12 along the band 10. Likewise, bulbous end portion 24 preferably extends more than one-half inch from the second end 14 along the band.

As noted above, the tool 1 may be stored on the head of a user between the scalp and the hair line. To ensure that the tool remains buried beneath the hair and does not protrude, the band 10 preferably has a thickness of less than ⅛ inch at least in the area between the first and second bulbous end portions.

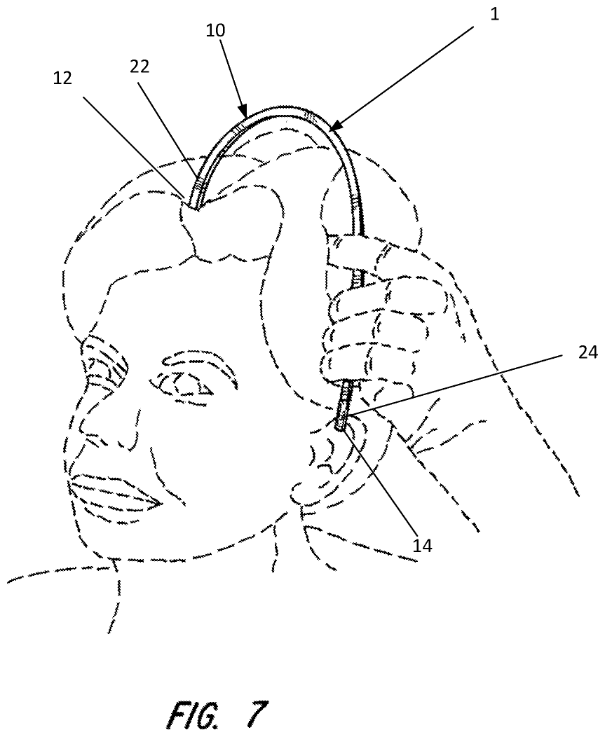

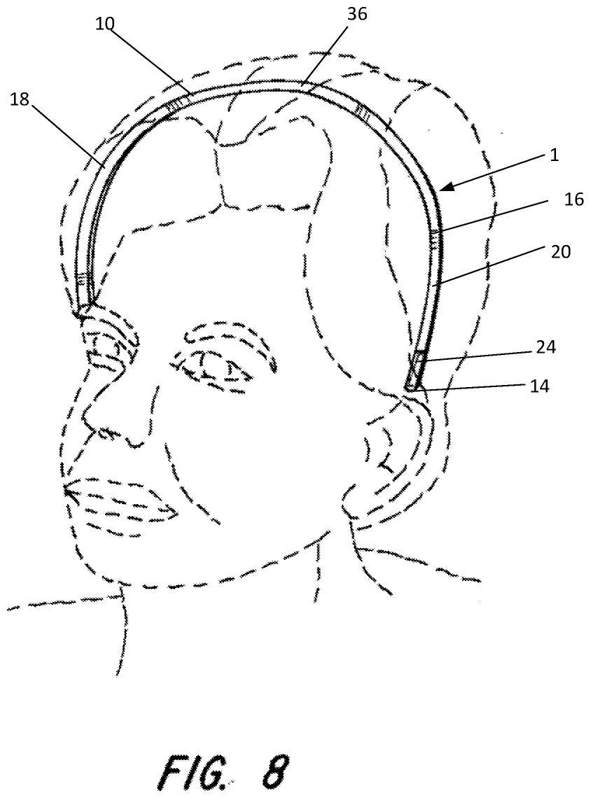

When the user experiences an itch, and the tool is stowed in the position shown in FIG. 8, the user can easily grip the second curved portion 20 as suggested by FIG. 7. The user then has the option of bringing into contact with the itching portion of the scalp either the bulbous end portion 22, the first curved portion 18, or both bulbous end portion 22 and the first curved portion 18. The tool 1 is then manipulated by the user, i.e., rubbed across the itching portion of the scalp, to alleviate the itch. After the itch is alleviated, the tool then may be reinserted into the stowed position illustrated in FIG. 8 between the scalp and the outer portion of the hair such that the tool is obscured from view.

A decorative element may also be employed. For example, to assist with hiding the tool beneath the hair when not in use, the tool 1 can be painted or otherwise colored to match the color of the user's hair. A camouflage pattern may also be employed. In some instances, for example when the user's hair is short such that the tool 1 cannot be fully buried between the scalp and the hair, the decorative element may be in the form of ribbons, bows, beads, flowers or any other type of decorative element pleasing to the user and adapted to be attached to the band 10.

As should be clear from the foregoing, the tool 1 offers various advantages. First, the tool 1 may be used to relieve itching of the scalp. The bulbous end portions 22 and 24 and the edges along the length of the band that engage the scalp are not sharp and are broad enough to prevent the tool from rupturing, puncturing, breaking or otherwise further irritating the skin. The tool 1, since it is designed to be unobtrusively worn on the skin beneath the hair, is always handy and readily available for use whenever an itching sensation arises. The tool 1 is also easily cleaned and sanitized.

Various modifications can, of course, be made, considering the disclosure provided, without deviating from the present invention. Thus, the disclosure is intended to be exemplary rather than limiting.

What is claimed is:

1. An itch relief tool comprising an elongate band having:
a. a first end;
b. a second end;
c. a transition zone;
d. a first curved portion having a first radius of curvature, extending between the first end and the transition zone;
e. a second curved portion, shorter than the first curved portion and having a second radius of curvature longer than the first radius of curvature, extending between the second end and the transition zone;
f. a first bulbous tip portion at the first end; and
g. a second bulbous tip portion at the second end.

2. The itch relief tool of claim 1 wherein the elongate band is made of a metallic material.

3. The itch relief tool of claim 2 wherein said first and second bulbous tip portions each comprise a coating applied to the elongate band.

4. The itch relief tool of claim 1 wherein said elongate band is made of a plastic material.

5. The itch relief tool of claim 1 wherein said first and second bulbous tip portions are integrally formed as a single piece with the rest of the elongate band.

6. The itch relief tool of claim 1 wherein the shortest distance between the first end and the second end is between 7 and 9 inches.

7. The itch relief tool of claim 1 wherein the shortest distance between the first end and the transition zone is between 4.5 and 5.5 inches.

8. The itch relief tool of claim 1 having a greatest depth of between 2.75 and 3.5 inches.

9. The itch relief tool of claim 1 wherein each of the first bulbous tip portions and second bulbous tip portion extends along the elongate band more than ½ inch.

10. The itch relief tool of claim 1 wherein the tool is made of materials that are adapted to be readily cleaned and sanitized.

11. The itch relief tool of claim 1 wherein the thickness of the elongate band in the area between the first and second bulbous end portions is less than ⅛ of an inch.

12. The itch relief tool of claim 1 wherein the band comprises a material selected from a group consisting of ivory, bronze, wood, porcupine quills, bone, carbon steel and nickel titanium.

13. The itch relief tool of claim 1 wherein the elongate band comprises a shape memory material.

14. The itch relief tool of claim 13 wherein the shape memory material has a transition temperature between 80° F. and 98.6° F.

15. The itch relief tool of claim 1 wherein the second curved portion is adapted to be gripped by the hand of a user and manipulated by the user while the first curved portion engages the scalp to address an itch.

16. The itch relief tool of claim 1 wherein the second curved portion is adapted to be gripped by the hand of a user and manipulated by the user while the first bulbous tip portion engages the scalp to address an itch.

17. The itch relief tool of claim 1 wherein the second curved portion is adapted to be gripped by the hand of a user and manipulated by the user while the first curved portion and the first bulbous tip portion engage the scalp to address an itch.

18. The itch relief tool of claim 1 wherein the tool is adapted to be stored on a user's head beneath the user's hair when not in use.

19. An itch relief tool comprising:
a. an elongate band having:
1) a first end;
2) a second end;
3) a first transition zone;
4) a first curved portion having a first radius of curvature, extending between the first end and the transition zone;
5) a second curved portion, shorter than the first curved portion and having a second radius of curvature longer than the first radius of curvature, extending between the second end and the transition zone;
b. a first bulbous tip portion extending from the first end along the elongate band; and
c. a second bulbous tip portion extending from the second end along the elongate band.

20. An itch relief tool comprising:
a. an elongate band made of a shape memory material having a transition temperature, such elongate band having:
1) a first end;
2) a second end;
3) a transition zone;
4) a first portion extending between the first end and the transition zone, said first portion adapted to form a first curve having a first radius of curvature when the shape memory material reaches its transition temperature;
5) a second portion extending between the second end and the transition zone, said second portion shorter than the first portion and adapted to form a second curve having a second radius of curvature longer than the first radius of curvature when the shape memory material reaches its transition temperature;
b. a first bulbous tip portion at the first end; and
c. a second bulbous tip portion at the second end.
